(19) United States
(12) Patent Application Publication
(10) Pub. No.: US 2003/0010544 A1
(43) Pub. Date: Jan. 16, 2003

(54) Low EMI digitizer tablet

(76) Inventors: Ching-Chuan Chao, Hsinchu (TW); Chih-An Chen, Hsinchu (TW)

Correspondence Address: SUPREME PATENT SERVICES, POST OFFICE BOX 2339, SARATOGA, CA, 95070, US

(21) Appl. No.: 09/902,178

(22) Filed: Jul. 10, 2001

(51) Int. Cl. G06K 11/06

(52) U.S. Cl. 178/18.01

(57) ABSTRACT

A low EMI digitizer tablet is covered with a shielding layer on an antenna circuit thereof to shield the digitizer tablet from invasion of electromagnetic interference (EMI) and thereby enhance the immunity of the digitizer tablet against noise.

### FIELD OF THE INVENTION

This invention relates generally to a digitizer tablet, particularly to a low EMI (Electromagnetic Interference) digitizer tablet.

### BACKGROUND OF THE INVENTION

In an electromagnetic induction digitizer tablet shown in FIGS. 1 and 2, an antenna circuit 1 usually comprises an X-axis antenna 11, a Y-axis antenna 12, a dielectric layer 13, and a metallic isolation layer 14.

Both the X-axis antenna 11 and the Y-axis antenna 12 are equidistantly spaced in an array so as to induce a stylus 15 and calculate the absolute coordinates thereof. The related principle works on the basis of magnetic flux variation caused by change of electromagnetic field of the stylus 15 to thereby have voltage variation induced in the digitizer tablet for calculating position of the stylus 15.

When the stylus 15 is placed adjacent to some antenna circuit of the digitizer tablet, the farther an antenna circuit is located from the stylus 15, a weaker voltage is induced in the antenna circuit and vice versa because the field intensity is inversely proportional to square of distance. A microprocessor in the digitizer tablet is programmed to scan all the antennas and analyze magnitude of the scanned voltages, the absolute coordinates of the stylus 15 are obtainable.

As a digitizer tablet is usually accompanied by some computer peripherals or information products operated in high frequencies, EMI is deemed inevitable that would considerably affect the accuracy in positioning the stylus, therefore, “ways to lessen or eliminate EMI” has already become a focus issue in recent days.

### SUMMARY OF THE INVENTION

The primary object of this invention is to provide a low EMI digitizer tablet, which is realized by coating a shielding layer on an antenna circuit to thereby shield the antenna circuit from invasion of any external electromagnetic interference.

For more detailed information regarding advantages or features of this invention, at least an example of preferred embodiment will be elucidated below with reference to the annexed drawings.

### BRIEF DESCRIPTION OF THE DRAWINGS

FIG. 1 shows the antenna circuit structure of a conventional digitizer tablet.

FIG. 2 shows the X- and Y-axis antenna of a conventional digitizer tablet.

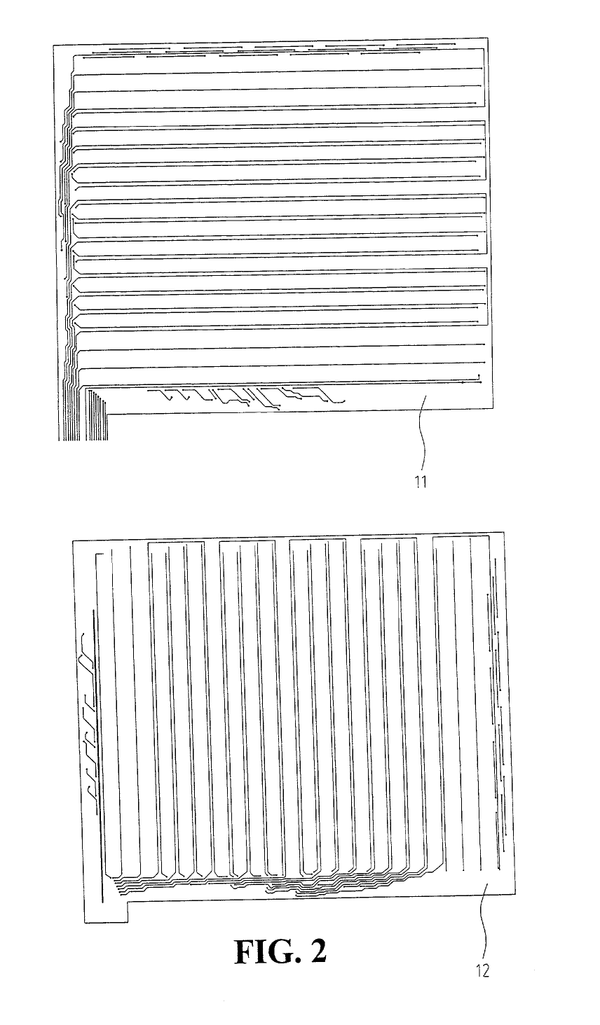

FIG. 3 shows an antenna circuit structure of a digitizer tablet of this invention.

FIG. 4 shows the grid structure of a shielding layer on an antenna circuit of the digitizer tablet of this invention.

FIG. 5 shows the circuitry arrangement of the X-axis (Y-axis) antenna of this invention.

### DETAILED DESCRIPTION OF THE INVENTION

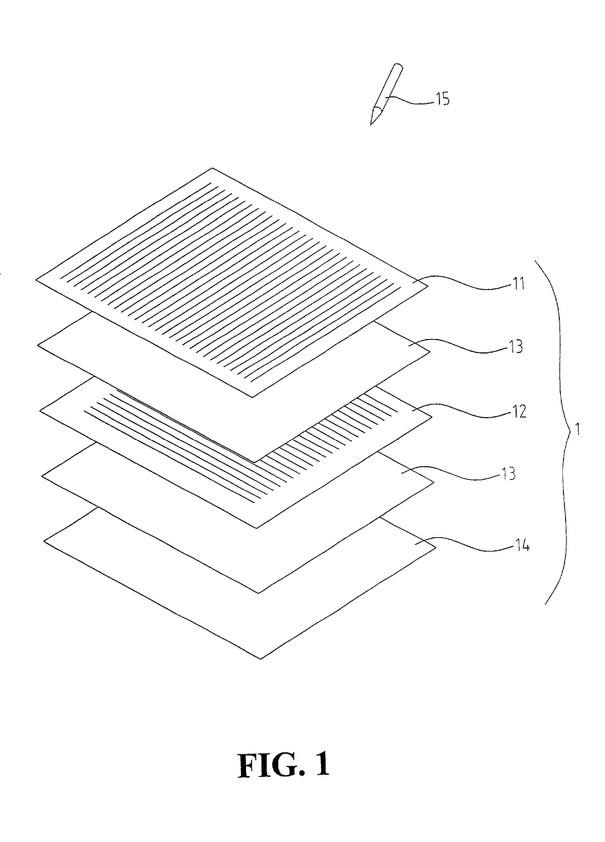

As illustrated in FIG. 1, a metallic isolation layer 14 (a metallic plate for example) is disposed under an antenna circuit 1 of a conventional digitizer tablet for grounding, therefore, the magnetic field created by a stylus 15 is inductively received by the top surface of the digitizer tablet. Similarly, the conventional digitizer tablet is interfered on its top surface by electromagnetic waves.

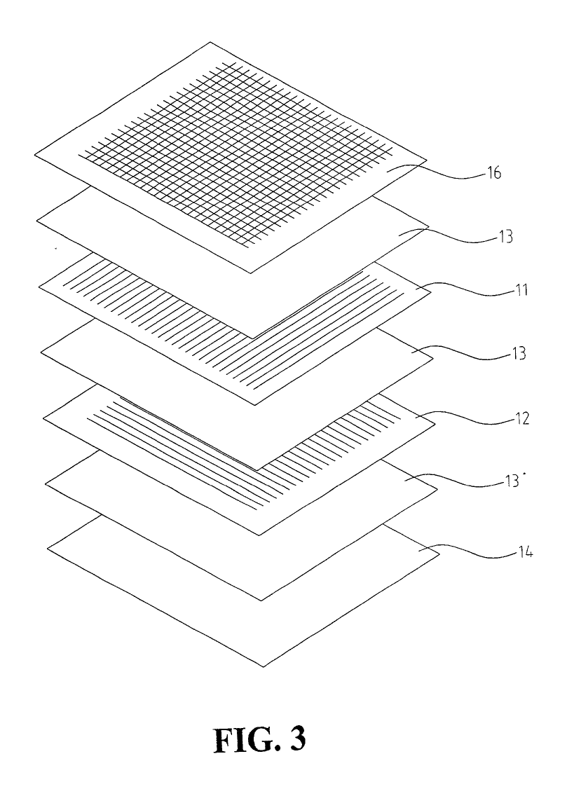

A low Electromagnetic interference (EMI) digitizer tablet of this invention shown in FIG. 3 is made by laying a dielectric layer 13 and a shielding layer 16 on the surface of an antenna circuit 1, wherein the shielding layer 16 is a conductor in net structure to shield the antenna circuit of the digitizer tablet from invasion of EMI.

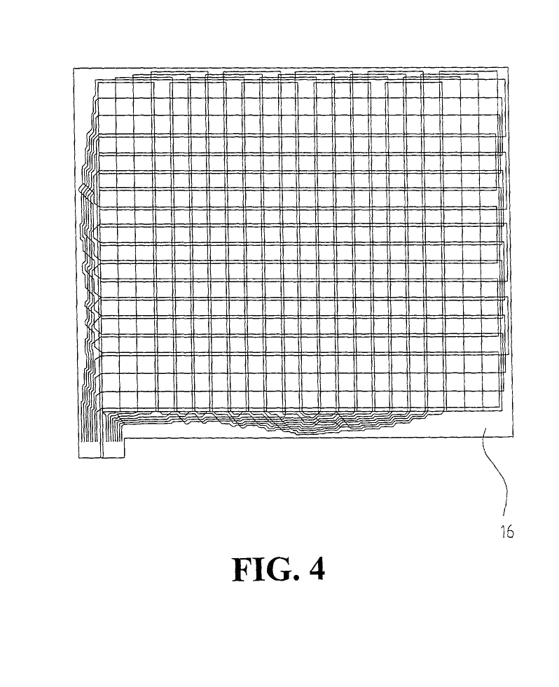

According to a preferred embodiment of this invention shown in FIG. 4, the shielding layer 16 in net structure is an antenna circuit composed of an X-axis and a Y-axis antenna 11, 12 for shielding the digitizer tablet from EMI without affecting the detection operation for magnetic flux variation caused by the stylus 15. Besides, the shielding layer 16 may be substituted with a uniformly laid conductor layer, which can pierce through the magnetic field without deteriorating detection of the magnetic field variation caused by the stylus 15.

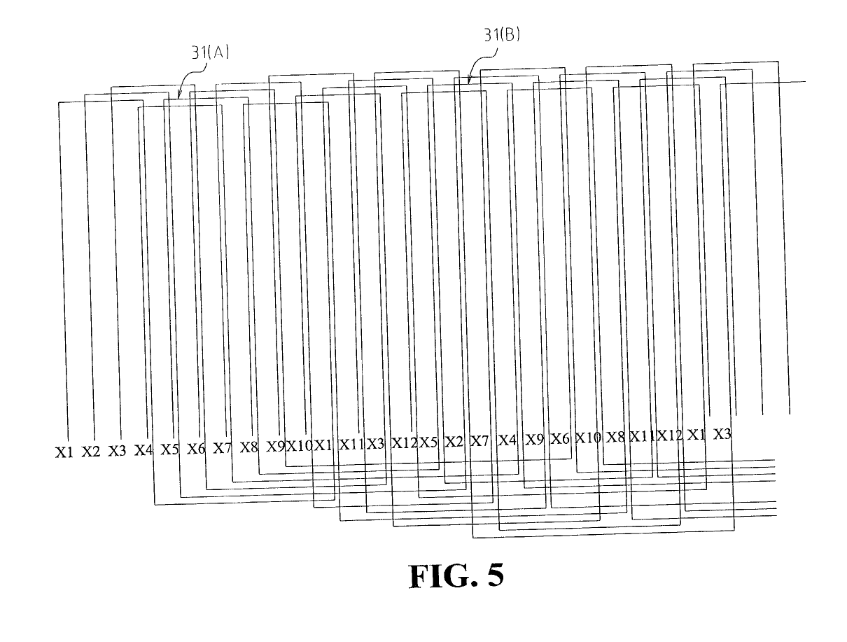

In this embodiment, the X-axis and the Y-axis antenna 11, 12 are composed of a plurality of [symbol] -shaped segmental antennas respectively. Taking the X-axis antenna for example, it comprises a plurality of component antenna sets X1˜X12, totally in 12 sets, as shown in FIG. 5, wherein each component antenna set Xn (n=1˜12) further comprises a plurality of [symbol] -shaped segmental antennas 31, wherein each segmental antenna 31 belongs to a component antenna set Xn different from that of its immediate neighbors for discrimination of a [symbol] -shaped segmental antenna 31 where the stylus is located. For instance, two immediate neighboring [symbol] -shaped segmental antennas 31 of two [symbol] -shaped segmental antennas 31 (A, B) of the component antenna set X₅ belong to the component antenna set X₄, X₆ and X₁₂, X₂ respectively. If the stylus 15 is located at the [symbol] -shaped segmental antenna 31 (A), this position can be confirmed by checking reference signal created by its immediate neighboring component antenna set X₄, X₆.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A low EMI digitizer tablet, having a dielectric layer and a shielding layer coated on an antenna circuit of the digitizer tablet, wherein the shielding layer is basically a conductor in net structure for shielding the digitizer tablet from invasion of electromagnetic interference (EMI).

2. The digitizer tablet according to claim 1, wherein the shielding layer is a uniformly laid conductor.

3. The digitizer tablet according to claim 1, wherein the pattern formed by the conductor in net structure covers the circuit patterns formed by a plurality of X-axis and Y-axis component antenna sets of the antenna circuit.

4. A low EMI digitizer tablet, having an antenna circuit comprising a plurality of X-axis and Y-axis antenna sets, dielectric layers, and a metallic isolation layer, wherein the dielectric layer is laid between the X-axis and the Y-axis antenna set and every two layers, and the metallic isolation layer is attached to the bottom face of the digitizer tablet which is characterized in:
a top surface of the antenna circuit being covered with a dielectric layer and a shielding layer, wherein the shielding layer is a conductor in net structure so as to shield the digitizer tablet from invasion of electromagnetic interference (EMI).

5. The digitizer tablet according to claim 4, wherein the shielding layer is a uniformly laid conductor.

6. The digitizer tablet according to claim 4, wherein the pattern formed by the conductor in net structure covers the circuit patterns formed by a plurality of X-axis and Y-axis component antenna sets of the antenna circuit.

7. The digitizer tablet according to claim 6, wherein both the X-axis and the Y-axis component antenna sets are composed of a plurality of [symbol] -shaped segmental antennas.
